(19) United States
(12) Patent Application Publication
(10) Pub. No.: US 2016/0328783 A1
(43) Pub. Date: Nov. 10, 2016

(54) INFORMATION PROCESSING APPARATUS, INFORMATION PROCESSING METHOD, AND PROGRAM

(71) Applicant: Rakuten, Inc., Tokyo (JP)

(72) Inventor: Yusuke SAKURAI, Tokyo (JP)

(73) Assignee: Rakuten, Inc., Tokyo (JP)

(21) Appl. No.: 15/212,516

(22) Filed: Jul. 18, 2016

Related U.S. Application Data
(63) Continuation of application No. 14/369,395, filed on Jun. 27, 2014.

(51) Int. Cl. G06Q 30/06; G06Q 10/08

(52) U.S. Cl. CPC G06Q 30/0635; G06Q 10/087; G06Q 30/0641

(57) ABSTRACT

Provided is an information processing apparatus including: a history storage unit that stores, as a user communication history, a history of communication with a user terminal made via the Internet regarding a purchase of a product; and an arrival notification unit that quantifies a purchase eagerness degree for the product for each of a plurality of users according to an increase in a stock quantity of the product based on the user communication history stored in the history storage unit, creates a priority order for the plurality of users based on the quantified purchase eagerness degree of each of the users, and notifies the user terminal of the plurality of users of an arrival of the product based on the priority order.

### CROSS REFERENCE TO RELATED APPLICATIONS

This application is a continuation of U.S. patent application Ser. No. 14/369,395, filed Jun. 27, 2014, which is a National Stage of International Application No. PCT/JP2013/001782, filed Mar. 15, 2013, the disclosures of which are incorporated herein by reference in their entireties.

### TECHNICAL FIELD

The present invention relates to an information processing apparatus suitable as a server for an electronic commerce system that uses the Internet as a communication medium, an information processing method, and a program.

### BACKGROUND ART

In recent years, an electronic commerce system using the Internet has been used as important means for product trading.

In such an electronic commerce system, a large number of products are speedily traded among a large number of shops and users as clients thereof. Therefore, products that are especially popular, rare products, and the like may become sold out within a short period of time since a large number of users access a webpage of a shop selling those products.

In this regard, a mechanism for notifying users by, for example, emails, that the sold-out product has arrived again at the shop is widely used. This mechanism can be used by a user clicking an arrival notification request button on a page of that product. A user ID, a product ID, and the like are managed by a server while being associated with one another, and as soon as being notified of the re-arrival of that product, the server searches for the user ID for which the arrival notification request for that product has been set and notifies the user of the re-arrival.

At this time, the arrival notification is concurrently made with respect to a large number of users in some cases. Therefore, some users may again lose a purchase opportunity due to a delay of a timing at which the notification reception is recognized, and thus such a procedure may be repeated. In this regard, there is proposed a technique of inquiring a user requesting an arrival notification of a request level regarding a product purchase and transmitting, by a server, a notification to a user with a higher request level when the product arrives (see, for example, Patent Document 1).

Patent Document 1: International Patent No. WO2003/038700

### SUMMARY OF INVENTION

### Problems to be Solved by the Invention

The known mechanism, however, lacks fairness across a plurality of users since the users themselves determine the request levels. For example, since many users are expected to set a high request level for a product that is especially popular, it is highly likely that there will consequently be users who will have the purchase opportunity and users who will not among the plurality of users.

Further, in addition to the problem described above, there are various points that are still not solved sufficiently in the electronic commerce system.

In view of the circumstances as described above, an object of the present invention is to provide an information processing apparatus, an information processing method, and a program with which a fair and user-friendly electronic commerce system can be provided to shops that use electronic commerce and users as clients thereof.

### Means for Solving the Problems

For attaining the object described above, according to the present invention, there is provided an information processing apparatus, including:

a history storage unit that stores, as a user communication history, a history of communication with a user terminal made via the Internet regarding a purchase of a product; and

an arrival notification unit that quantifies a purchase eagerness degree for the product for each of a plurality of users according to an increase in a stock quantity of the product based on the user communication history stored in the history storage unit, creates a priority order for the plurality of users based on the quantified purchase eagerness degree of each of the users, and notifies the user terminal of the plurality of users of an arrival of the product based on the priority order.

The information processing apparatus may further include a request acceptance unit that accepts a request for an arrival notification regarding an out-of-stock product from the user terminal, and the history storage unit may store, as the user communication history, a history of a request accepted by the request acceptance unit for each of the users.

The history storage unit may store, as the user communication history, the number of times the request has been accepted by the request acceptance unit.

The history storage unit may store, as the user communication history, a time and date at/on which the request has been accepted by the request acceptance unit.

The history storage unit may store, as the user communication history, an access history with respect to a webpage presenting information related to the product for each of the users.

The history storage unit may store, as the user communication history, the number of accesses with respect to the webpage.

The history storage unit may store, as the user communication history, a time and date at/on which the webpage has been accessed.

The history storage unit may store, as the user communication history, a history of the arrival notification of the product.

The history storage unit may store, as the user communication history, the number of arrival notifications of the product.

The history storage unit may store, as the user communication history, a time and date of the arrival notification of the product.

The arrival notification unit may notify the plurality of user terminals of the arrival while shifting a time based on the priority order.

The arrival notification unit may vary a shift amount of the time based on a value of the purchase eagerness degree.

The information processing apparatus according to the present invention may further include an arrival schedule notification unit that quantifies, when arrival schedule information including at least an arrival scheduled date of the product is received, the purchase eagerness degree of the product for each of the users based on the user communication history stored in the history storage unit, creates the priority order for the plurality of users based on the quantified purchase eagerness degree of each of the users, and notifies the user terminal of the plurality of users of an arrival of the product based on the priority order.

The information processing apparatus according to the present invention may further include a demand degree notification unit that generates demand degree information of the product based on the user communication history stored in the history storage unit and notifies a terminal of a shop selling the product.

### Effect of the Invention

As described above, according to the present invention, a fair and user-friendly electronic commerce system can be provided to shops that use electronic commerce and users as clients thereof.

### BRIEF DESCRIPTION OF DRAWINGS

FIG. 1 A diagram showing an example of an overall structure of an electronic commerce system according to an embodiment of the present invention.

FIG. 2 A diagram showing a display example of a product page.

FIG. 3 A diagram showing a screen example of the product page when a product is out of stock.

FIG. 4 A diagram showing an example of an arrival notification mail.

FIG. 5 A block diagram showing a functional structure of a sale management server.

FIG. 6 A diagram showing a structure of stock data.

FIG. 7 A diagram showing a structure of user data.

FIG. 8 A diagram showing a structure of arrival notification data.

FIG. 9 A diagram showing a structure of history data of an arrival notification request.

FIG. 10 A diagram showing an example of an arrival announcement mail.

FIG. 11 A flowchart showing processing of the sale management server and a user terminal, that is executed when a user of the user terminal accesses a product page.

FIG. 12 A flowchart showing processing executed when the sale management server makes an arrival notification.

FIG. 13 A flowchart showing processing of an arrival schedule notification unit.

FIG. 14 A flowchart showing processing of a product demand degree notification unit.

FIG. 15 A diagram showing a structure of history data of an arrival notification request that uses an average time interval of an accepted time and date of the arrival notification request.

FIG. 16 A block diagram showing a functional structure of the sale management server in the electronic commerce system according to a second embodiment.

FIG. 17 A flowchart showing processing of the sale management server and the user terminal, that is executed when the user of the user terminal accesses a product page in the electronic commerce system shown in FIG. 16.

FIG. 18 A flowchart showing processing executed when the sale management server makes an arrival notification in the electronic commerce system shown in FIG. 16.

FIG. 19 A diagram showing a structure of product page access history data that uses an average time interval of an access time and date.

FIG. 20 A diagram showing a structure of the product page access history data that uses the number of accesses.

FIG. 21 A diagram showing a hardware structure of the sale management server, the user terminal, and a shop terminal.

### MODES FOR CARRYING OUT THE INVENTION

### 1. First Embodiment

Hereinafter, a first embodiment of the present invention will be specifically described with reference to the drawings.

It should be noted that herein, a case where an electronic commerce system according to the present invention is applied to an electronic commerce system that sells a product using the Internet will be described.

[1-1. Structure of Electronic Commerce System]

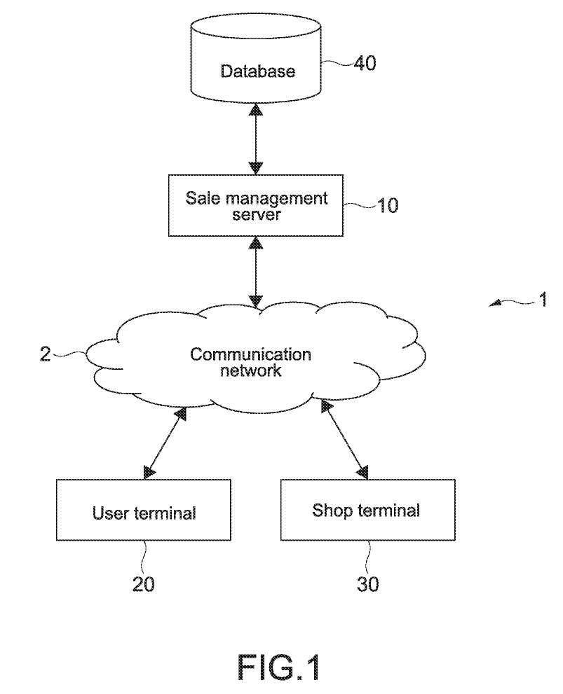

FIG. 1 is a diagram showing an example of an overall structure of an electronic commerce system according to an embodiment of the present invention.

As shown in FIG. 1, the electronic commerce system 1 includes a sale management server 10, a user terminal 20, a shop terminal 30, and a database 40. The sale management server 10 is connectable to the user terminal 20 and the shop terminal 30 via a communication network 2.

The sale management server 10 carries out various types of processing for providing, via a webpage, services related to electronic commerce of a product, such as an introduction of a product provided by the shop terminal 30, a product purchase, and a presentment of a re-arrival of a sold-out product. The sale management server 10 is realized by hardware elements such as a server computer and software elements such as an operating system, an application program, and other data.

The user terminal 20 is connected to the sale management server 10 via the communication network 2 and used for a search, reservation, and purchase of a product, a request for receiving a notification upon re-arrival of a sold-out product, a transmission of a request, and the like in addition to a browse of a webpage related to the product.

The shop terminal 30 is connected to the sale management server 10 via the communication network 2 and used for uploading information on a sale product to the sale management server 10, and the like.

Specifically, the user terminal 20 and the shop terminal 30 are a cellular phone (including smartphone), a mobile information terminal (including tablet computer), a personal computer, and the like.

It should be noted that the hardware structures of the sale management server 10, the user terminal 20, and the shop terminal 30 will be described later in detail.

The sale management server 10 can access the database 40. The database 40 stores various types of data requisite for electronic commerce of products. Specifically, the sale management server 10 can access the database 40 and perform various operations such as a storage, update, search, and deletion of various types of data in the database 40. The data stored in the database 40 will be described later.

It should be noted that the database 40 may be structured in the sale management server 10 or structured in a different server from the sale management server 10. In this embodiment, a structure in which the sale management server 10 accesses the database 40 structured outside the sale management server 10 is assumed.

[1-2. Basic Flow of Electronic Commerce]

Next, a basic flow up to a purchase of a product sold at a shop by a user will be described.

It is assumed that the user terminal 20 has accessed the sale management server 10 and is displaying a product page downloaded from the sale management server 10 on a display unit.

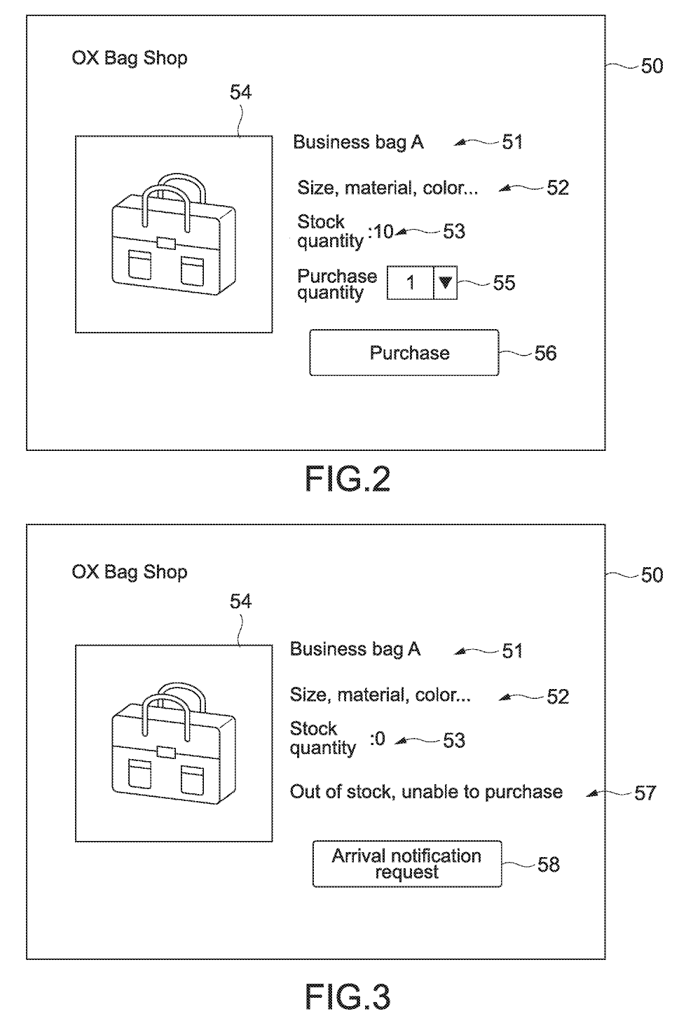

FIG. 2 is a diagram showing a display example of the product page. The product page 50 is a page of a product of each type sold at a shop. In the product page 50, a product name and product ID 51, basic information 52 on a product, a current stock quantity 53, a product photograph 54, and the like are displayed. The product page 50 includes, in addition to the text information described above, an input form 55 used for the user to input a quantity of a product to be purchased and a purchase button 56 used for the user to purchase a product.

In the product page 50, the stock quantity of the product is “10”, that is, there is a stock of the product at the shop. The input form 55 and the purchase button 56 are arranged in the product page 50 when there is a stock of the product as in the example shown in the figure. When the user wishes to purchase the product, the user operates the purchase button 56 after setting the quantity to be purchased in the input form 55. Accordingly, a purchase request including data on a product purchase, such as a product ID allocated to the product and the purchase quantity, is transmitted to the sale management server 10, and the sale management server 10 that has received the purchase request generates a webpage for inputting data related to product trading, such as a delivery address and a settlement method, and responds to the user terminal 20 of the user. As the data related to product trading is input by the user on the webpage displayed on the display unit of the user terminal 20 and a confirmation button is operated, the data related to product trading is transmitted to the sale management server 10.

Upon receiving the information related to product trading from the user terminal 20, the sale management server 10 accesses the database 40 and updates various types of data stored in the database 40. For example, the sale management server 10 performs an update so as to subtract the stock quantity of the relevant product from the stock data stored in the database 40 based on the data related to a product purchase, such as the product ID and purchase quantity transmitted while being incorporated into the purchase request. Furthermore, the data related to product trading, that has been transferred from the user terminal 20, is registered in the target database.

Moreover, the data related to a product purchase such as a product ID and a purchase quantity and the data related to product trading such as a delivery address and a settlement method are transmitted from the sale management server 10 to the shop terminal 30 via the communication network 2. Upon receiving the data, the shop terminal 30 performs a procedure for delivering the product by a staff of the shop based on the data.

As described above, when there is a stock of the product, the user can purchase the product from the product page 50. However, when the product is out of stock, the user cannot purchase the product.

FIG. 3 is a diagram showing a screen example of the product page 50 when a product is out of stock. As shown in the figure, in the product page 50, the current stock quantity 53 is “0”, and a message 57 indicating that a product cannot be purchased due to a lack of stock and an arrival notification request button 58 for requesting an arrival notification when the product arrives at the shop are provided in place of the input form 55 and the purchase button 56.

In a typical service, as the user operates the arrival notification request button 58 of the product page 50, an arrival notification request including a user ID for identifying the user, a product ID for identifying the product, and an email address of the user if necessary is transmitted from the user terminal 20 to the sale management server 10. It should be noted that in the case of a user who has completed a user registration in advance as a member of the electronic commerce service, the user ID and the email address are already registered in the database 40 in association with each other. Therefore, in this case, the email address does not need to be incorporated into the arrival notification request.

In a typical service, upon receiving the arrival notification request, the sale management server 10 stores the user ID, product ID, email address, and the like included in the arrival notification request in the database 40 in association with one another as arrival notification data. In other words, a user ID of each user that has transmitted an arrival notification request, a product ID, an email address, and the like are associated with one another and stored in the database 40 as single arrival notification data.

In a typical service, data notifying that an out-of-stock product has arrived is transmitted from the shop terminal 30 to the sale management server 10, and when that arrived product is an out-of-stock product, the sale management server 10 searches for arrival notification data including a product ID of that arrived product in the database 40. Then, the sale management server 10 issues an arrival notification indicating that the product has arrived to the user terminal 20 of the user that has transmitted the arrival notification request with respect to the product based on the searched arrival notification data.

Here, the arrival notification with respect to the user terminal 20 is made through, for example, an email or a webpage for an arrival notification. Hereinafter, the arrival notification is assumed to be made through an email. An email for the arrival notification will hereinafter be referred to as “arrival notification mail”.

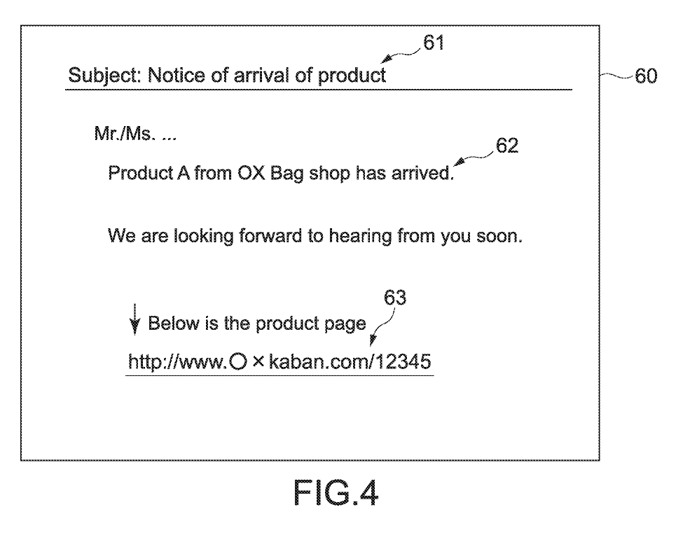

FIG. 4 is a diagram showing an example of the arrival notification mail.

As shown in the figure, the arrival notification mail 60 includes a title 61 indicating that a product has arrived, a message body 62, and a hyperlink 63 with respect to the product page 50.

In the user terminal 20, the user performs an operation of opening the arrival notification mail 60, and when the hyperlink 63 provided in a text of the opened arrival notification mail 60 is clicked, the user terminal 20 downloads the product page 50 and displays it on the display unit.

Accordingly, the user can grasp that a product for which the arrival notification request has been transmitted has re-arrived and further confirm the current stock quantity by accessing the product page 50.

However, there is a case where a product that has arrived at the shop is sold out at an instant to become out of stock at a time point the user accesses the product page 50 using the hyperlink 63. In this case, since the user cannot purchase the product from that shop, the user may operate the arrival notification request button 58 again to transmit the arrival notification request to the sale management server 10. In the case of a popular product that is attracting attention from many users or a product on which a strict shipment restriction is placed, individual users need to repetitively make the arrival notification request, which is a burden for the users. Depending on the users, there may be a restriction on a time and date at/on which the arrival notification mail 60 can be opened due to a difference in working styles, times the users come home, and the like. In contrast, a time and date at/on which the arrival notification mail 60 is delivered is generally irregular or depends on an arrival notification time and date from the shop. Due to the circumstances as described above, there may be users who can easily purchase a product and users who cannot.

In this regard, this embodiment aims at improving fairness among users who are wishing to purchase a product in the electronic commerce service as much as possible.

[1-3. Functional Structure of Sale Management Server 10]

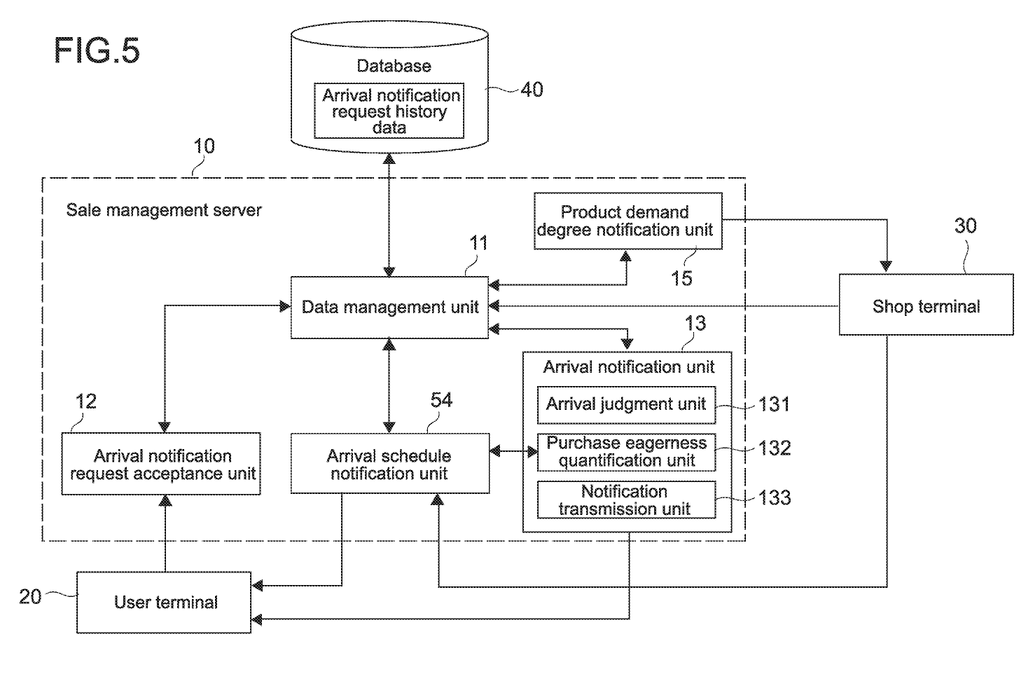

FIG. 5 is a block diagram showing a functional structure of the sale management server 10.

As shown in the figure, the sale management server 10 includes, as the functional structure, a data management unit 11, an arrival notification request acceptance unit 12, an arrival notification unit 13, an arrival schedule notification unit 14, and a product demand degree notification unit 15, that are functional units realized by a CPU of the sale management server 10 executing a program stored in a main memory.

(1-3-1. Data Management Unit 11)

The data management unit 11 manages data requisite for providing a service related to electronic commerce of products, such as an introduction of products, a purchase of products, and a presentment of a re-arrival of a sold-out product using the database 40. By the data management unit 11, stock data related to a stock of a product of each shop, user data related to each user using the electronic commerce system 1, arrival notification data for identifying a user who has made an arrival notification request, history data (user communication history) of an arrival notification request from a user terminal, and the like are stored in the database 40.

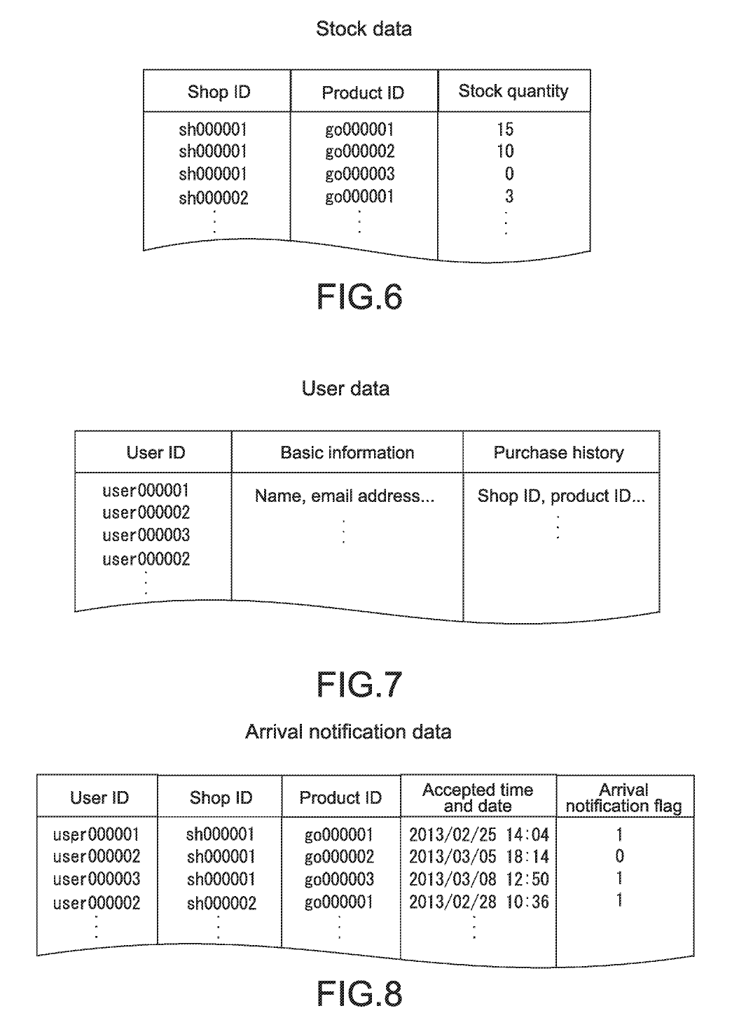

FIG. 6 is a diagram showing a structure of the stock data.

The stock data is constituted of a shop ID for identifying a shop, a product ID for identifying a product handled in the shop, a stock quantity of the product, and the like. Here, as a purchase request from the user terminal 20 is received by the sale management server 10, the data management unit 11 decrements the stock quantity by a purchase quantity, and as an arrival notification from the shop terminal 30 of the shop is received by the sale management server 10, the data management unit 11 increments the stock quantity by the quantity that has arrived.

FIG. 7 is a diagram showing a structure of the user data.

The user data is constituted of a user ID for identifying a user, basic information on the user (e.g., name, email address, contact information, and delivery address), a purchase history on a product that the user has purchased in the past (e.g., shop ID, product ID, purchase quantity, and purchase time and date), and the like.

For example, when the user registers to use the electronic commerce system 1, the user data of the user is registered as a new record in the database 40. After the registration, the user can use the service of the electronic commerce system 1. As the user purchases a product, the purchase history corresponding to the user is updated.

FIG. 8 is a diagram showing a structure of the arrival notification data.

The arrival notification data is constituted of a user ID, a shop ID, a product ID, an accepted time and date of an arrival notification request, an arrival notification flag, and the like. The user whose user ID is stored in the arrival notification data is a user who has transmitted the arrival notification request.

As the user operates the arrival notification request button 58 in the product page 50, an arrival notification request including a user ID, a shop ID, and a product ID is transmitted from the user terminal 20 to the sale management server 10. As the sale management server 10 receives the arrival notification request, the data management unit 11 registers the user ID, shop ID, product ID, accepted time and date of an arrival notification request, and arrival notification flag included in the arrival notification request in the database 40 as one record of the arrival notification data. The arrival notification flag indicates that the arrival notification has been accepted when its value is “1” and indicates that the arrival notification has not been accepted when its value is “0”. Therefore, when the arrival notification request button 58 of the product page 50 is operated in the user terminal 20, the value of the arrival notification flag is automatically set to “1”. The value of the arrival notification flag becomes a condition for determining whether to transmit to the user terminal 20 the arrival notification mail 60 for notifying an arrival of a product when there uprises a stock quantity in stock data due to the arrival of a product. In other words, it is determined that the arrival notification mail 60 is to be transmitted to a relevant user when the value of the arrival notification flag is “1” and determined not to transmit the arrival notification mail 60 to the user terminal 20 when the value of the arrival notification flag is “0”. Such a determination is made by the arrival notification unit 13.

It should be noted that when the arrival notification mail 60 for notifying an arrival of a product is transmitted to the user whose value of the arrival notification flag is “1”, the value of the arrival notification flag is reset to “0” from “1”. As a result, the user of the user terminal 20 who has once received the arrival notification mail 60 will not receive the arrival notification mail 60 for notifying the arrival of a product as long as the user does not operate the arrival notification request button 58 of the product page 50 again.

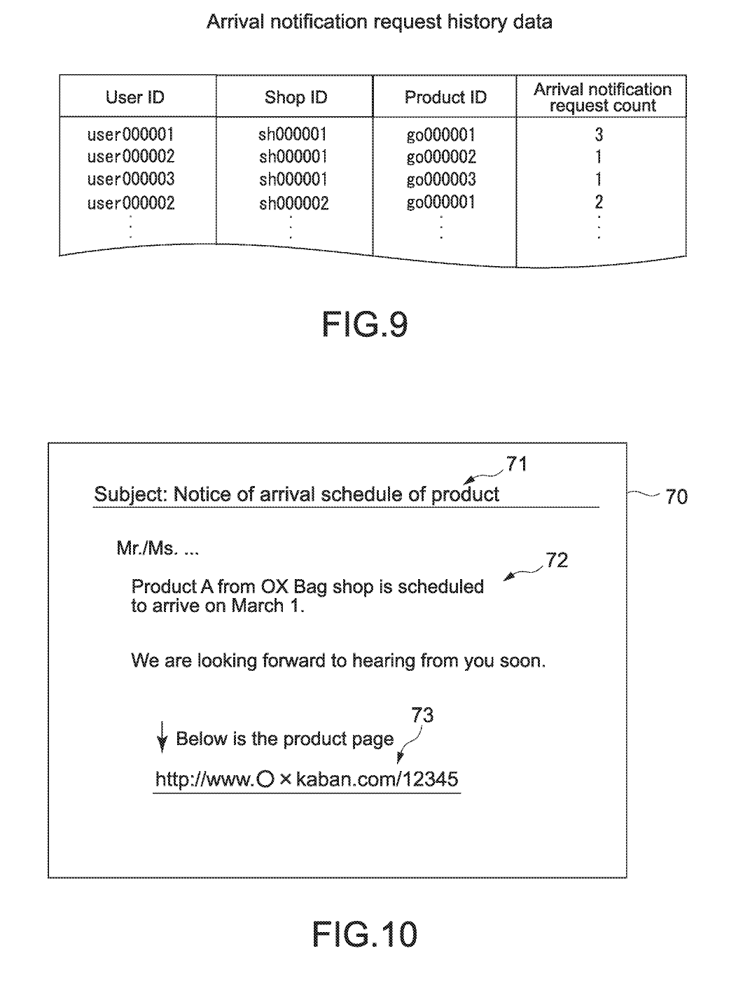

FIG. 9 is a diagram showing a structure of the history data of an arrival notification request.

The arrival notification request history data is constituted of a user ID, a shop ID, a product ID, an arrival notification request count, and the like. Here, the arrival notification request count is the number of times an arrival notification request has been notified to the sale management server 10 by the user operating the arrival notification request button 58 in the user terminal 20.

When the user operates the arrival notification request button 58 in the product page 50, an arrival notification request including a user ID, a shop ID, and a product ID is transmitted from the user terminal 20 to the sale management server 10. As the sale management server 10 receives the arrival notification request, the data management unit 11 searches for an update target record based on the user ID, shop ID, and product ID included in the arrival notification request and when there is not an update target record, registers the user ID, the shop ID, the product ID, and the arrival notification request count “1” in the database 40 as one record of the arrival notification request history data. When an update target record already exists, the data management unit 11 increments the value of the arrival notification request count of the update target record.

It should be noted that the record of the arrival notification request history data is deleted as a purchase of the product ends, for example. In other words, the arrival notification request count increases but does not decrease until the purchase of the product ends.

(1-3-2. Arrival Notification Request Acceptance Unit 12)

The arrival notification request acceptance unit 12 accepts the arrival notification request transmitted in correspondence with an event that the user has operated the arrival notification request button 58 of the product page 50 in the user terminal 20. The arrival notification request acceptance unit 12 hands over the data of the user ID, shop ID, product ID, and the like included in the accepted arrival notification request to the data management unit 11. The data management unit 11 that has received the data of the user ID, shop ID, product ID, and the like from the arrival notification request acceptance unit 12 registers the arrival notification data and registers or updates the arrival notification request history data as described above based on the data stored with those data in the database 40.

(1-3-3. Arrival Notification Unit 13)

The arrival notification unit 13 includes an arrival judgment unit 131, a purchase eagerness quantification unit 132, and a notification transmission unit 133.

The arrival judgment unit 131 monitors a stock quantity of a relevant record in the stock data with respect to a combination of a shop ID and a product ID of a record registered in the arrival notification request history data, and when there uprises a stock quantity (arrival occurs), hands over the combination of the shop ID and product ID of the record for which the stock quantity has uprose to the purchase eagerness quantification unit 132.

The purchase eagerness quantification unit 132 compares the combination of the shop ID and product ID handed over from the arrival judgment unit 131 with the combination of the shop ID and product ID in the arrival notification request history data and judges a record of the arrival notification request history data whose IDs have matched. The purchase eagerness quantification unit 132 quantifies a purchase eagerness degree of the product for each user ID in the judged record of the arrival notification request history data.

In this embodiment, the purchase eagerness quantification unit 132 quantifies the purchase eagerness degree of the product for each user corresponding to the user ID based on the arrival notification request count. For example, the value of the arrival notification request count can be used as it is as a value that indicates the purchase eagerness degree. The purchase eagerness quantification unit 132 hands over a combination of the obtained value indicating the purchase eagerness degree of a product and the user ID for each user to the notification transmission unit 133.

The notification transmission unit 133 creates a priority order among users based on the combination of the value indicating the purchase eagerness degree of a product and the user ID for each user acquired from the purchase eagerness quantification unit 132. For example, as the value indicating the purchase eagerness degree increases, a higher priority order is allocated to that user. The notification transmission unit 133 transmits the arrival notification mail 60 to the user terminal 20 of each user based on the created priority order.

There are the following methods of transmitting the arrival notification mail 60 to the user terminal 20 of a plurality of users based on the created priority order.

1. A method of using, as a priority order, an order in which email addresses of users are listed in a transmission order in a mail transmission list created for each product in a shop when collectively transmitting the arrival notification mail 60 to the user terminals 20 of the users.

2. A method of dividing, when transmitting the arrival notification mail 60 to the user terminals 20 of the users in a certain time zone (e.g., 1 day, 12 hours, 6 hours, 3 hours, and 1 hour), the certain time zone into a plurality of time zones and allocating each of the divided time zones to each of the priority orders. In this case, the higher priority order the user is allocated, the earlier time zone is allocated to that user.

3. A method of reflecting a value indicating a purchase eagerness degree of a user onto a length of time allocated to a divided time zone. For example, when a value indicating a purchase eagerness degree of a user A is “5” and that of a user B is “1” in a case where 6 hours is given as the entire mail transmission time, the first 5 hours is allocated to the time zone for transmitting the arrival notification mail 60 to the user A having the highest priority order, and the remaining 1 hour is allocated to the time zone for transmitting the arrival notification mail 60 to the user B having the second-highest priority order.

(1-3-4. Arrival Schedule Notification Unit 14)

The arrival schedule notification unit 14 transmits to the purchase eagerness quantification unit 132, upon receiving arrival schedule information including an arrival scheduled date and arrival quantity of a product from the shop terminal 30, a purchase eagerness degree quantification request including a shop ID of a shop as a transmission source of the arrival schedule information and a product ID of an arrival scheduled product. Upon receiving the purchase eagerness degree quantification request from the arrival schedule notification unit 14, the purchase eagerness quantification unit 132 compares the combination of the shop ID and product ID included in the request with the combination of the shop ID and product ID in the arrival notification request history data and judges a record of the arrival notification request history data whose IDs have matched. The purchase eagerness quantification unit 132 quantifies a purchase eagerness degree of the product for each user ID in the judged record of the arrival notification request history data and transmits the result to the arrival schedule notification unit 14 as a response.

Similar to the notification transmission unit 133 of the arrival notification unit 13, the arrival schedule notification unit 14 creates a priority order among users based on the combination of the value indicating the purchase eagerness degree of a product and the user ID for each user, that has been acquired from the purchase eagerness quantification unit 132. For example, as the value indicating the purchase eagerness degree increases, a higher priority order is allocated to that user. The notification transmission unit 133 transmits the arrival notification mail to the user terminal 20 of each user based on the created priority order.

(1-3-6. Product Demand Degree Notification Unit 15)

The product demand degree notification unit 15 generates demand degree information of each product based on the arrival notification request history data or arrival notification data carries out processing for notifying the shop terminal 30. Periodically (every other day, every other week, etc.) or upon receiving a product demand degree notification request from the shop terminal 30, for example, the product demand degree notification unit 15 generates the demand degree information of each product based on the arrival notification request history data or the arrival notification data.

[1-4. Processing Executed by Electronic Commerce System 1 According to First Embodiment]

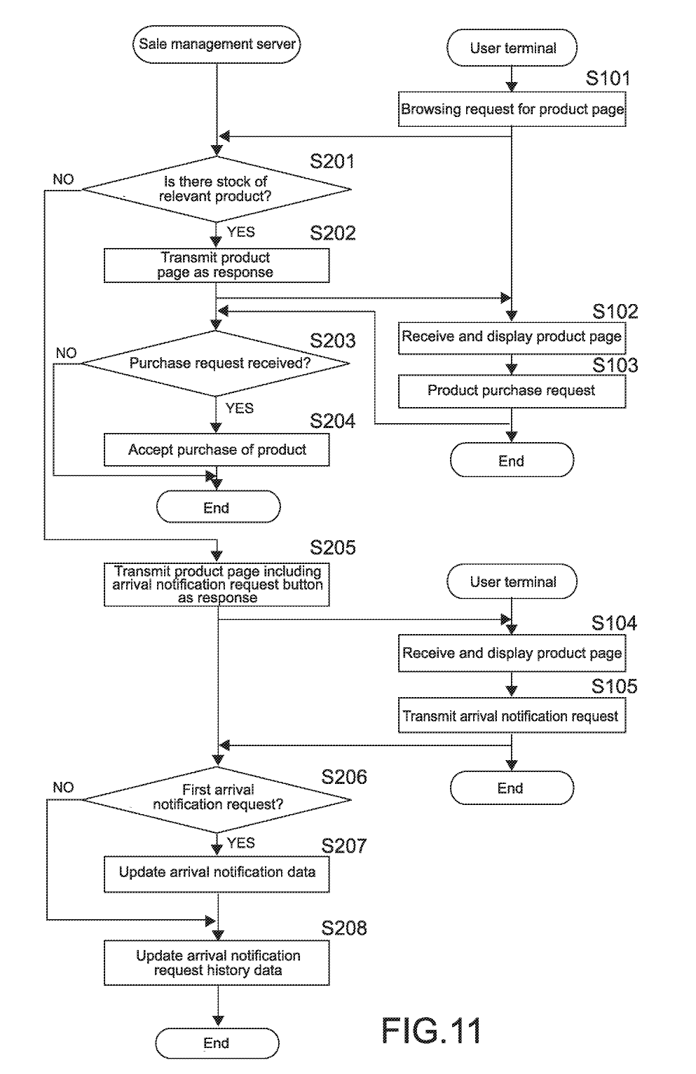

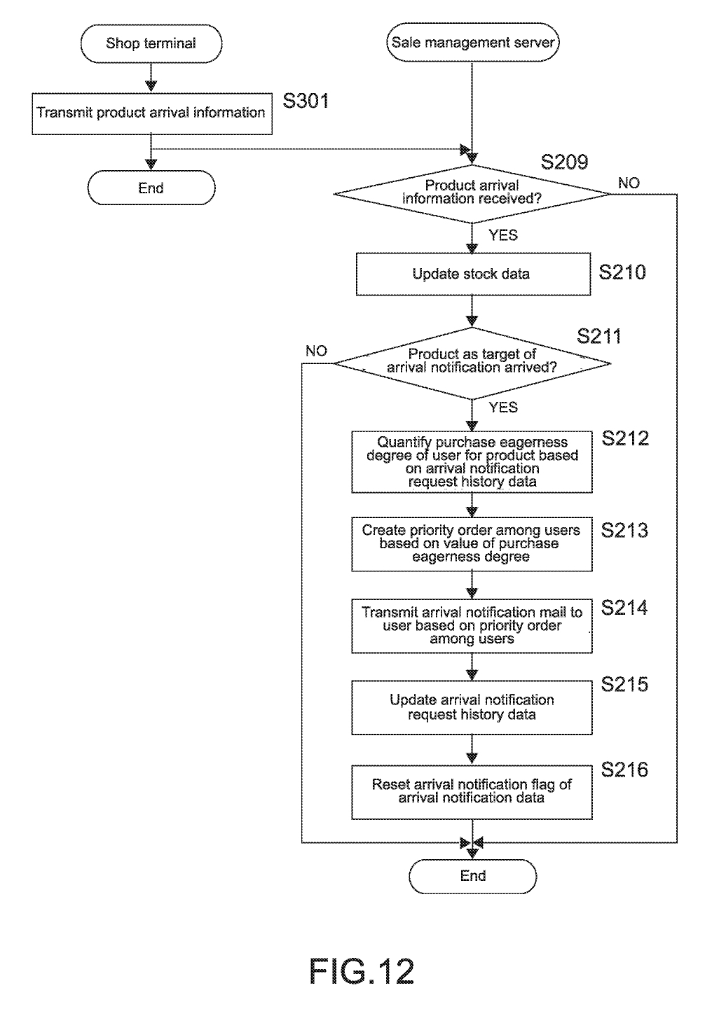

FIGS. 11 and 12 are diagrams each showing processing executed by the electronic commerce system 1. FIG. 11 shows processing of the sale management server 10 and the user terminal 20, that is executed when the user of the user terminal 20 accesses the product page 50. FIG. 12 shows processing executed when the sale management server 10 makes an arrival notification.

First, the processing shown in FIG. 11 will be described.

Hereinafter, the expression “sale management server 10” means “CPU of the sale management server 10”. Similarly, the expression “user terminal 20” means “CPU of the user terminal 20”, and “shop terminal 30” means “CPU of the shop terminal 30”. Human-induced processing will be clarified using the word “user” as in “user of the user terminal 20”.

It is assumed that currently, a session is established between the sale management server 10 and the user terminal 20, and a user has completed a given login operation.

First, the user terminal 20 transmits a browsing request for the product page 50 to the sale management server 10 according to a user operation (e.g., operation of selecting link to product page 50) (Step S101). It should be noted that when information is transmitted from the user terminal 20 to the sale management server 10, an IP address, a user ID, and the like are transmitted. Accordingly, the sale management server 10 can specify which user is accessing the product page 50.

Upon receiving the browsing request for the product page 50, the sale management server 10 references stock data and judges whether there is a stock of a product corresponding to the product page 50 (Step S201). Here, a URL of the product page 50 is stored in the database 40 in association with the shop ID and product ID. Therefore, upon receiving the browsing request for the product page 50, the sale management server 10 searches for the shop ID and product ID associated with the browsing target URL included in the browsing request and compares the combination of the shop ID and product ID with the stock data to search for a relevant record in the stock data and confirm a stock quantity of the record. As a result, it is possible to grasp whether there is a stock.

When judged that there is a stock of the product (YES in Step S201), the sale management server 10 generates a product page 50 including the input form 55 and the purchase button 56 and transmits it to the user terminal 20 (Step S202).

The user terminal 20 receives the product page 50 and displays it on the display unit (Step S102). Accordingly, the product page 50 as shown in FIG. 2 is displayed on the display unit of the user terminal 20.

After that, product purchase processing is carried out according to a user operation (Step S103). The purchase processing and the purchase acceptance processing of the sale management server 10 (Steps S203 and S204) are as described above as general processing.

On the other hand, when judged that there is no stock of the product (NO in Step S201), the sale management server 10 generates a product page 50 used when there is no stock of a product (see FIG. 3) and transmits it to the user terminal 20 (Step S205).

The user terminal 20 receives the product page 50 used when there is no stock of a product from the sale management server 10 and displays it (Step S104). The arrival notification request button 58 is provided in the product page 50 used when there is no stock of a product. Therefore, the user operates the arrival notification request button 58 when wishing to purchase the product. Accordingly, an arrival notification request including a user ID, a shop ID, and a product ID is transmitted from the user terminal 20 to the sale management server 10 (Step S105).

In the sale management server 10, the arrival notification request acceptance unit 12 accepts the arrival notification request from the user terminal 20 and supplies it to the data management unit 11. The data management unit 11 compares a combination of the user ID, shop ID, and product ID included in the arrival notification request with the arrival notification data already stored in the database 40, and when the combination does not exist in the arrival notification data, assumes the arrival notification request as a first arrival notification request with respect to the current combination of the user ID, shop ID, and product ID (YES in Step S206) and adds a new record constituted of the user ID, shop ID, product ID, accepted time and date of the arrival notification request, and arrival notification flag “1” to the arrival notification data (Step S207). After that, the data management unit 11 newly registers a combination of the user ID, shop ID, product ID, and arrival notification request count “1” to the arrival notification request history data as one record (Step S208).

Further, when the combination of the user ID, shop ID, and product ID included in the arrival notification request already exists in the arrival notification data, the data management unit 11 judges that the arrival notification request is not the first arrival notification request (NO in Step S206) and updates the arrival notification request history data (Step S207). Specifically, the update of the arrival notification request history data is carried out by incrementing the arrival notification request count of the relevant record in the arrival notification request history data.

Next, the processing for an arrival notification with respect to the user will be described with reference to FIG. 12.

First, information on an arrival of a product is transmitted from the shop terminal 30 to the sale management server 10 (Step S301). The information on an arrival of a product includes a shop ID, a product ID of a product that has arrived, and a quantity that has arrived.

In the sale management server 10, the data management unit 11 acquires the information on an arrival of a relevant product (YES in Step S209) and updates stock data (Step S210).

When an update of the stock data occurs, the arrival notification unit 13 activates the arrival judgment unit 131. The arrival judgment unit 131 checks, with respect to a combination of the shop ID and product ID of the record registered in the arrival notification request history data, a stock quantity of the relevant record in the stock data. Here, when the product has not newly arrived, the stock quantity is “0”, but when the product has newly arrived, the stock quantity is “1” or more. As described above, the arrival judgment unit 131 can grasp whether the arrival notification target product has arrived (Step S211).

Upon grasping that the arrival notification target product has arrived (YES in Step S211), the arrival judgment unit 131 hands over a combination of the shop ID and product ID of the record for which the stock quantity has uprose by the arrival of the product to the purchase eagerness quantification unit 132. The purchase eagerness quantification unit 132 compares the combination of the shop ID and product ID handed over from the arrival judgment unit 131 with a combination of the shop ID and product ID in the arrival notification request history data and judges a record of the arrival notification request history data whose IDs have matched. Then, the purchase eagerness quantification unit 132 quantifies the purchase eagerness degree of the product for each user ID in the judged record of the arrival notification request history data (Step S212). The method of quantifying the purchase eagerness degree of a product is as described above.

Subsequently, the purchase eagerness quantification unit 132 hands over a combination of the obtained value indicating the purchase eagerness degree of the product and the user ID for each user to the notification transmission unit 133. The notification transmission unit 133 creates a priority order among the users based on the combination of the value indicating the purchase eagerness degree of the product and the user ID for each user, that has been acquired from the purchase eagerness quantification unit 132 (Step S213). The specific method of creating the priority order among users is as described above.

Next, the notification transmission unit 133 transmits the arrival notification mail 60 to the user terminal 20 of each user based on the created priority order (Step S214). The specific method of transmitting the arrival notification mail 60 to the user terminal 20 of each user based on the created priority order is as described above.

Subsequently, the notification transmission unit 133 updates the arrival notification request history data. The update of the arrival notification request history data is carried out by incrementing the value of the arrival notification request count. In other words, the value of the arrival notification request count in the arrival notification request history data is incremented “1” at a time along with the transmission of an arrival notification to the user terminal 20.

Next, the notification transmission unit 133 resets the arrival notification flag of the arrival notification data (Step S216). In other words, the value of the arrival notification flag in the arrival notification data is updated from “1” to “0” along with the transmission of the arrival notification to the user terminal 20.

In general, there may be a case where a product that has re-arrived is already sold out at a time point the user of the user terminal 20 accesses the product page 50 after receiving and opening the arrival notification mail 60. In this embodiment, however, since the value of the arrival notification request count in the arrival notification request history data is incremented by the arrival notification request transmitted from the user terminal 20 to the sale management server 10 by the user operating the arrival notification request button 58 again after that, the priority order of the next arrival notification is highly likely higher than the past one. Therefore, unfairness that a certain user cannot purchase the product even when the product re-arrives again and again can be largely alleviated.

Next, processing of the arrival schedule notification unit 14 of the sale management server 10 will be described.

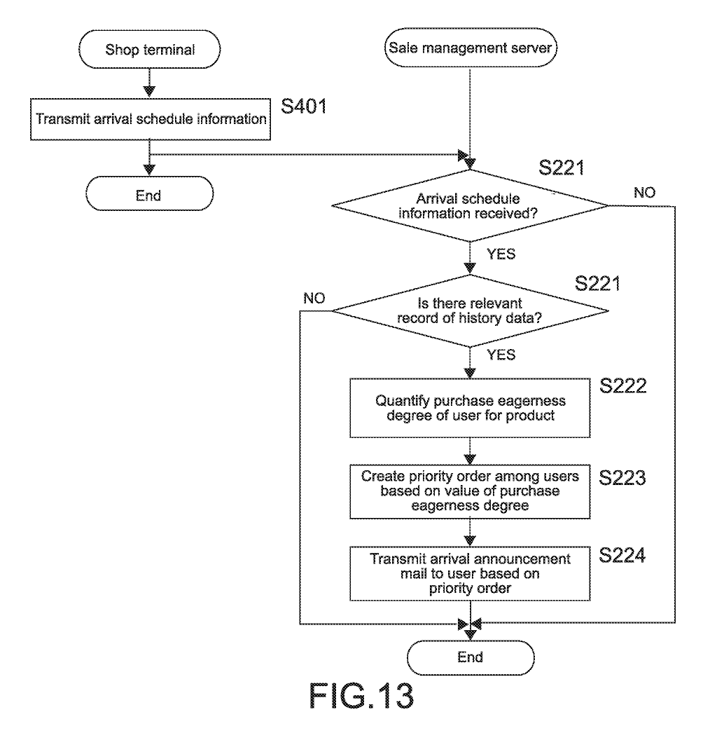

FIG. 13 is a flowchart showing the processing of the arrival schedule notification unit 14.

First, schedule information on an arrival scheduled product is transmitted from the shop terminal 30 to the sale management server 10 (Step S401). The schedule information on an arrival scheduled product includes a shop ID, a product ID of an arrival scheduled product, an arrival scheduled date, and an arrival scheduled quantity.

In the sale management server 10, upon receiving the arrival schedule information from the shop terminal 30 (Step S221), the arrival schedule notification unit 14 transmits a purchase eagerness degree quantification request including a shop ID of a shop as a transmission source of the arrival schedule information and a product ID of the arrival scheduled product to the purchase eagerness quantification unit 132.

Upon receiving the purchase eagerness degree quantification request from the arrival schedule notification unit 14, the purchase eagerness quantification unit 132 compares the combination of the shop ID and product ID included in the purchase eagerness degree quantification request with the combination of the shop ID and product ID in the arrival notification request history data and judges a record of the arrival notification request history data whose IDs have matched (Step S221).

Upon judging the relevant record of the arrival notification request history data, the purchase eagerness quantification unit 132 quantifies a purchase eagerness degree of the product for each user ID in the record (Step S222) and transmits the result to the arrival schedule notification unit 14 as a response.

Similar to the notification transmission unit 133 of the arrival notification unit 13, the arrival schedule notification unit 14 creates a priority order among users based on the combination of the value indicating the purchase eagerness degree of a product and the user ID for each user, that has been acquired from the purchase eagerness quantification unit 132 (Step S223). Then, the notification transmission unit 133 transmits an arrival announcement mail to the user terminal 20 of each user based on the created priority order (Step S224).

FIG. 10 is a diagram showing an example of an arrival announcement mail 70.

As shown in the figure, the arrival announcement mail 70 includes a title 71 indicating that a product is to arrive, a message body 72 of an arrival schedule, and a hyperlink 73 with respect to the product page 50.

In the user terminal 20, the user performs an operation of opening the arrival announcement mail 70, and when the hyperlink 73 provided in a text of the opened arrival announcement mail 70 is clicked, the user terminal 20 receives the product page 50 and displays it on the display unit. Accordingly, the user can grasp the scheduled date on which the product for which an arrival notification request has been made arrives.

It should be noted that although a case of transmitting the arrival notification mail 60 and the arrival announcement mail 70 as an arrival notification and arrival schedule notification is assumed in this embodiment, it is also possible to create a webpage for the arrival notification or arrival schedule notification and transmit it to the user terminal 20.

Next, processing of the product demand degree notification unit 15 of the sale management server 10 will be described.

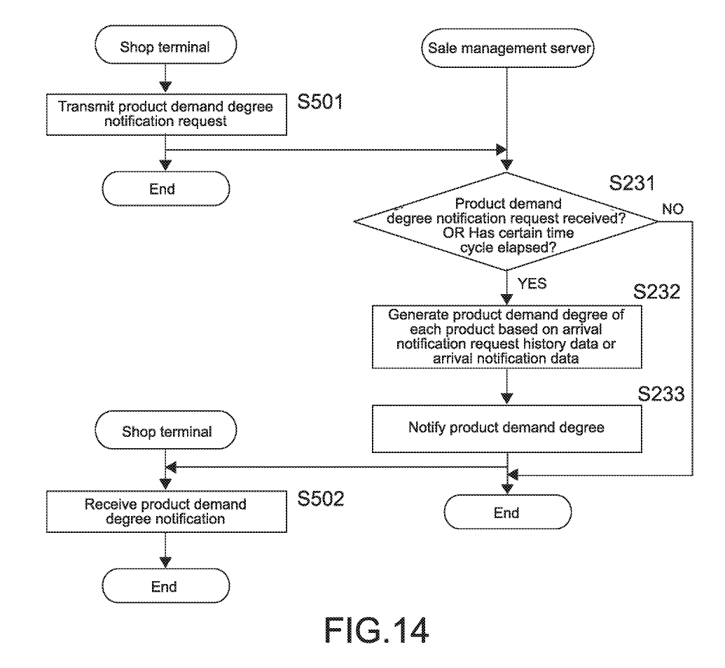

FIG. 14 is a flowchart showing the processing of the product demand degree notification unit 15.

Periodically (every other day, every other week, etc.) or upon receiving a product demand degree notification request from the shop terminal 30 (YES in Step S231), for example, the product demand degree notification unit 15 generates demand degree information of each product based on the arrival notification request history data or the arrival notification data (Step S232). Specifically, for example, the product demand degree notification unit 15 generates, as the demand degree information, a cumulative value of an arrival notification request count of each product for one shop. Alternatively, the demand degree information of each product may be quantified based on the number of users whose arrival notification flag is set to “1”. After that, the product demand degree notification unit 15 notifies the shop terminal 30 of the generated demand degree information of each product in the form of an email or a webpage (Step S233).

In the embodiment above, the arrival notification request count has been used as the arrival notification request history data for quantifying the purchase eagerness degree of a product. However, an average time interval of an accepted time and date of an arrival notification request may be used as the arrival notification request history data for the quantification.

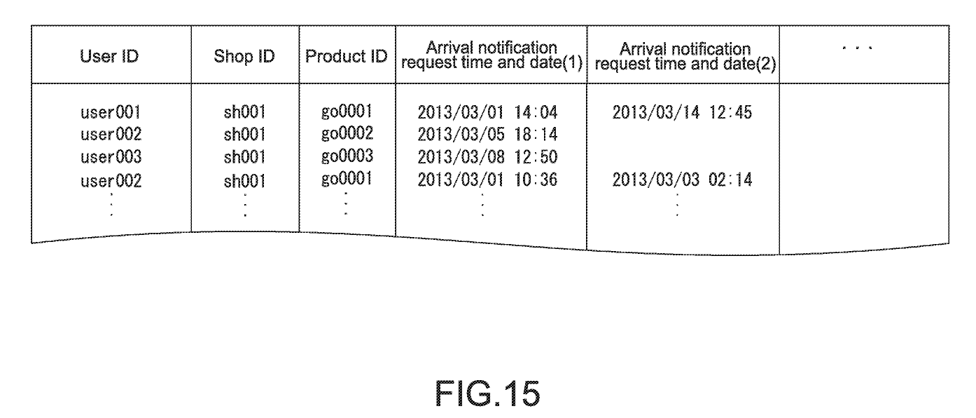

FIG. 15 is a diagram showing a structure of the arrival notification request history data that uses the average time interval of an accepted time and date of an arrival notification request.

In FIG. 15, it is assumed that a user whose user ID is “user001” and a user whose user ID is “user002” have set an arrival notification request with respect to the same product (ID=“goh0001”) of the same shop (ID=“sh001”). Moreover, the arrival notification request counts of the users are both “2”. In such a state, by using or adding the average time interval of an accepted time and date of an arrival notification request as an index of the quantification of the purchase eagerness degree, a difference between the priority orders of the users can be provided appropriately.

In this example, while the average time interval of an accepted time and date of an arrival notification request regarding the user ID “user001” is “about 13 days”, the average time interval of an accepted time and date of an arrival notification request regarding the user ID “user002” is “about 1 day”. In such a case, it is judged that the user having a shorter average time interval of an accepted time and date of an arrival notification request has more purchase eagerness, and thus the priority order of the users is determined as user001<user002.

### 2. Second Embodiment

Next, a second embodiment of the present invention will be described.

In the first embodiment above, the arrival notification request button 58 has been provided in the product page 50, and the number of times an arrival notification request of a product is explicitly transmitted from a user has been used as an index for indicating a purchase eagerness degree of the user with respect to the product.

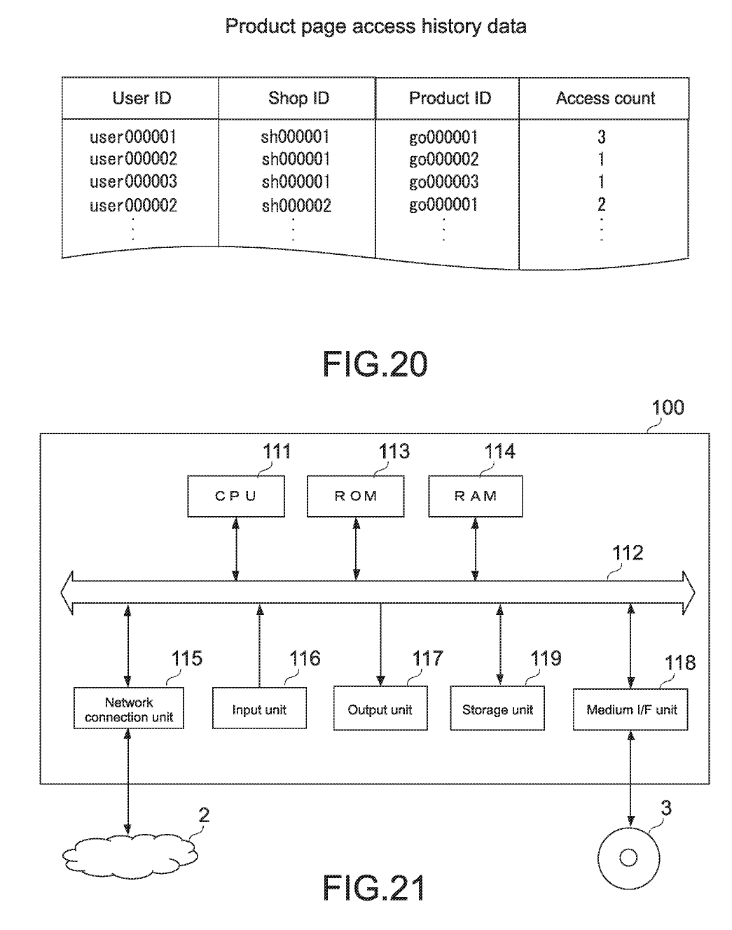

In the second embodiment, the number of times the user accesses a product page or the like is recorded as a product page access history as shown in FIG. 20 so that the product page access history is used as the index for indicating a purchase eagerness degree of a user with respect to a product instead of the explicit arrival notification request transmission count from the user.

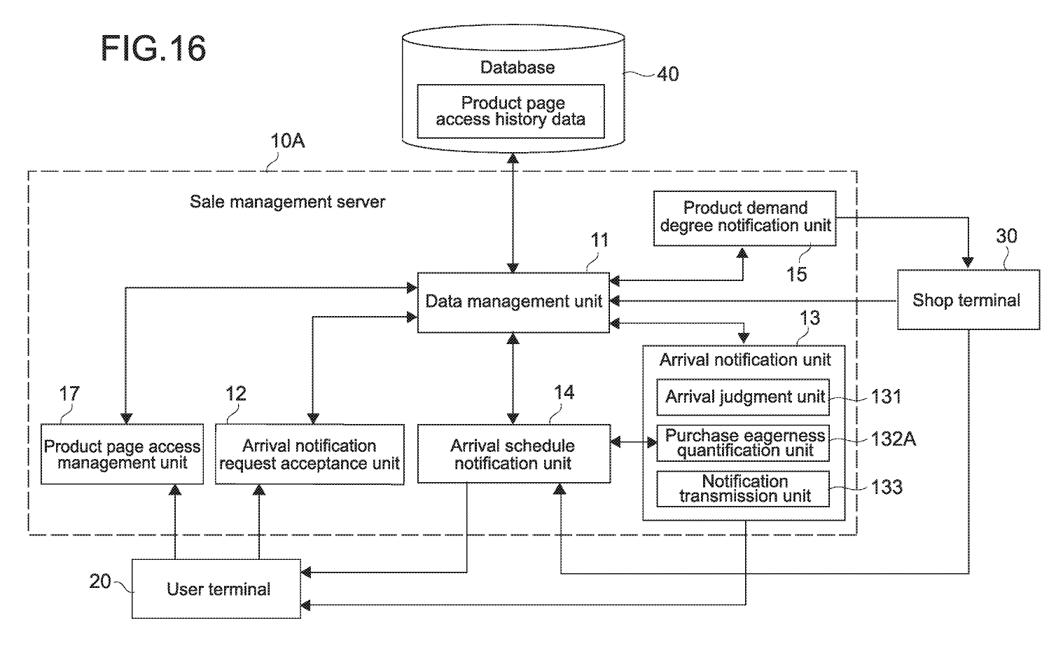

FIG. 16 is a block diagram showing a functional structure of a sale management server 10A in the electronic commerce system 1 of this embodiment.

A point different from that of the functional structure of the sale management server 10 of the first embodiment is that a product page access management unit 17 is added, and product page access history data is stored in the database 40 as a user communication history in place of the arrival notification request history data. In addition, in the arrival notification unit 13, a purchase eagerness quantification unit 132A quantifies a purchase eagerness degree of a product of each user based on the product page access history data instead of quantifying the purchase eagerness degree of a product of each user based on the arrival notification request history data.

(2-1. Product Page Access Management Unit 17)

The product page access management unit 17 hands over the user ID of the user of the user terminal 20, a shop ID of a shop associated with the accessed product page 50, and a product ID of a product associated with the accessed product page 50 to the data management unit 11. When a record whose user ID, shop ID, and product ID match is not registered in the product page access history data of the database 40, the data management unit 11 newly registers the user ID, shop ID, product ID, and an initial value “1” of the access count in the product page access history data of the database 40 as a record. Further, when a record whose user ID, shop ID, and product ID match is already registered in the database 40, the access count value of the relevant record in the product page access history data stored in the database 40 is incremented.

[2-1. Processing Executed by Electronic Commerce System of Second Embodiment]

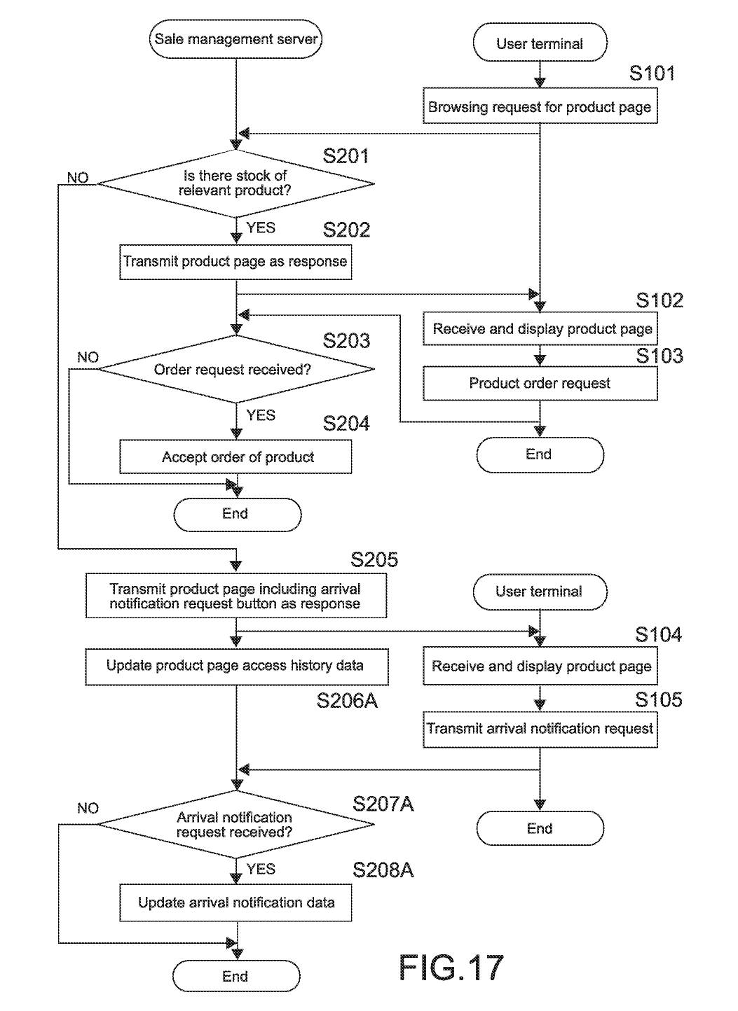

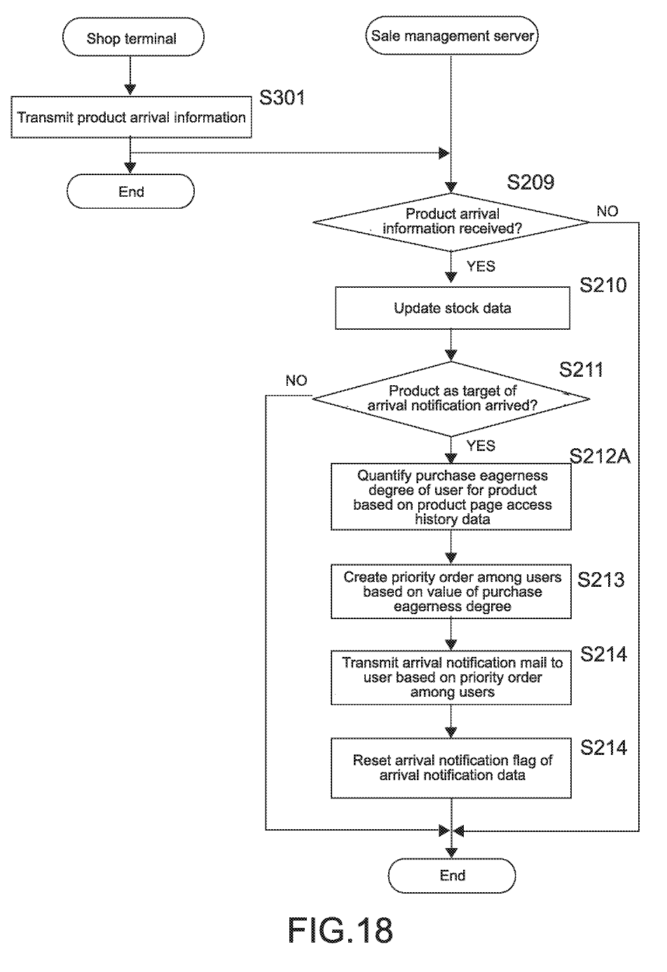

FIGS. 17 and 18 are diagrams each showing processing executed by the electronic commerce system of the second embodiment. FIG. 17 is a flowchart showing processing of the sale management server 10A and the user terminal 20, that is executed when the user of the user terminal 20 accesses the product page 50. FIG. 18 is a flowchart showing processing executed when the sale management server 10A makes an arrival notification.

In FIG. 17, since the operations of the user terminal 20 from Step S101 to Step S105 are the same as those of FIG. 11 of the first embodiment, descriptions thereof will be omitted. Moreover, in the sale management server 10A, since the operations from Step S201 to Step S205 are the same as those of FIG. 11 of the first embodiment, descriptions thereof will be omitted.

In the second embodiment, after the sale management server 10A generates the product page 50 used when there is no stock of a product (see FIG. 3) and transmits it to the user terminal 20 in Step S205, the product page access history data of the database 40 is updated (Step S206A).

More specifically, the product page access management unit 17 hands over the user ID of the user of the user terminal 20, a shop ID of a shop associated with the accessed product page 50, and a product ID of a product associated with the accessed product page 50 to the data management unit 11. When a record whose user ID, shop ID, and product ID match is not registered in the product page access history data of the database 40, the data management unit 11 newly registers the user ID, shop ID, product ID, and the initial value “1” of the access count in the product page access history data of the database 40 as a record.

Further, when a record whose user ID, shop ID, and product ID match is already registered in the database 40, the access count value of the relevant record in the product page access history data stored in the database 40 is incremented.

Specifically, this embodiment has characteristics that, regardless of whether an arrival notification request is to be transmitted by the user operating the arrival notification request button 58 of the product page 50 in the user terminal 20, an access history is stored in the database 40 when the product page 50 is accessed.

Next, with reference to FIG. 18, the processing executed when the sale management server 10A makes an arrival notification will be described.

In this embodiment, since the operations of the steps of the sale management server 10A excluding Step S212A are the same as those shown in FIG. 12 of the first embodiment, descriptions thereof will be omitted.

In Step 212A, the purchase eagerness quantification unit 132A of the sale management server 10A quantifies a purchase eagerness degree of a product for each user based on the product page access history stored in the database 40.

As described above, in this embodiment, it is possible to generate the priority order among the users using the product page access history data such as the number of times the user has accessed the product page as an index for indicating the purchase eagerness degree of the user with respect to the product, and notify the user of the arrival based on the priority order. As a result, as in the first embodiment, fairness at the time the users purchase a product upon receiving the arrival notification can be improved.

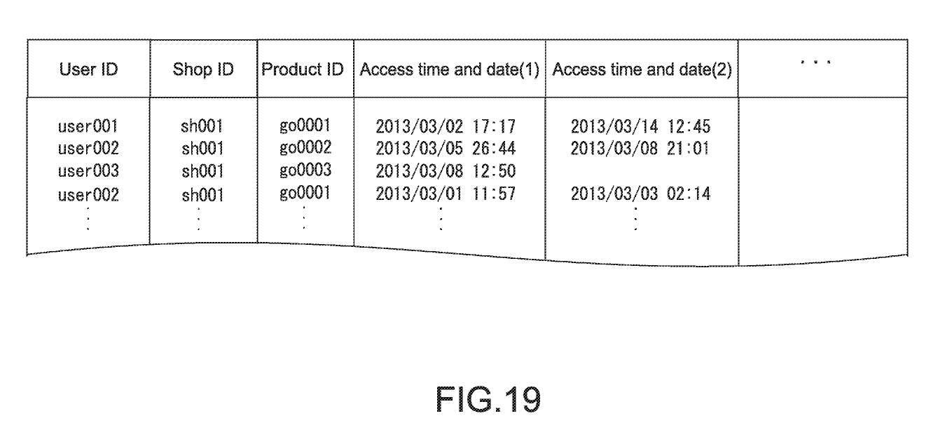

It should be noted that in the second embodiment, an average time interval of an access time and date can be used as the product page access history data in place of the number of times the product page is accessed as shown in FIG. 19. Alternatively, the purchase eagerness degree of a user with respect to a product can be quantified using both the number of times the product page is accessed and the average time interval of an access time and date.

### 3. Modified Example

In the descriptions above, the method of quantifying the purchase eagerness degree of a product using the arrival notification request count/request time and date and the product page access count/access time and date as the user communication history has been described. However, it is also possible to quantify the purchase eagerness degree of a product using the arrival notification count from the sale management server 10 to the user terminal 20 and the notification time and date as the user communication history.

### 4. Hardware Structures of Sale Management Server, User Terminal, and Shop Terminal

Lastly, hardware structures of the sale management server, the user terminal, and the shop terminal will be described.

FIG. 21 is a diagram showing the hardware structures of the sale management server 10, the user terminal 20, and the shop terminal 30.

A CPU 111, a system bus 112, a ROM 113, a RAM 114, a network connection unit 115, an input unit 116, an output unit 117, a medium I/F unit 118, and a storage unit 119 are included. The CPU (Central Processing Unit) 111 interprets and executes an operating system and application program loaded in the RAM 114 used as a main memory to exchange various types of information with the network connection unit 115, the input unit 116, the output unit 117, the medium I/F unit 118, the storage unit 119, and the like and execute various types of operational processing.

The network connection unit 115 carries out processing for connecting to a communication network such as the Internet. The input unit 116 and the output unit 117 are means for a user interface and hardware elements essential for mainly the user terminal 20 and the shop terminal 30. The input unit 116 and the output unit 117 may be incorporated as a touch panel display, for example. Alternatively, a combination of an input-dedicated device such as a keyboard and a mouse and a display-dedicated device such as a CRT (Cathode Ray Tube) and an LCD (Liquid Crystal Display) may be used.

The medium I/F unit 118 enables a removable medium 3 such as a magnetic disk, an optical disc, and a semiconductor memory to be detachable. The sale management server 10, the user terminal 20, and the shop terminal 30 are capable of loading an application program read from the removable medium 3 or, conversely, storing internal data in the removable medium 3. The storage unit 119 is realized by a nonvolatile memory such as a hard disk drive.

### DESCRIPTION OF REFERENCE NUMERALS

1 electronic commerce system
2 communication network
10 sale management server
11 data management unit
12 arrival notification request acceptance unit
13 arrival notification unit
14 arrival schedule notification unit
15 product demand degree notification unit
17 product page access management unit
20 user terminal
30 shop terminal
40 database
50 product page
58 arrival notification request button
60 arrival notification mail
131 arrival judgment unit
132 purchase eagerness quantification unit
133 notification transmission unit

1. A sale management server, comprising:
at least one memory configured to store computer program code, image data, and the arrangement information;
at least one processor configured to access said memory, read said computer program code, and execute according to said computer program code;
and a storage,
said computer program code comprising:
generation code configured to cause at least one of said at least one processor to, in response to a browsing request for a product page of a product from a user terminal, generate a first webpage configured to accept a purchase request in response to the product being an in-stock product and generate a second webpage configured to accept an arrival notification request in response to the product being an out-of-stock product;
transmission code configured to cause at least one of said at least one processor to transmit the generated first webpage or the generated second webpage to the user terminal;
request acceptance code configured to cause at least one of said at least one processor to accept a request for an arrival notification regarding the out-of-stock product from the user terminal;
history storage code configured to cause at least one of said at least one processor to store a history of the request for the same product for each of a plurality of users in the storage, that has been accepted in accordance with the request acceptance code; and
arrival notification code configured to cause at least one of said at least one processor to:
calculate a purchase eagerness value for the product for each of the users based on the number of requests for each of the users in the history stored in the storage,
create a priority order for the plurality of users based on the calculated purchase eagerness value of each of the users, and
notify the user terminal of the plurality of users of an arrival of the product based on the priority order.

2. The sale management server according to claim 1,
wherein the arrival notification code is further configured to cause at least one of said at least one processor to allocate, when a plurality of users are judged to have the same purchase eagerness value, a higher priority to a user having a shorter average time interval regarding an acceptance time and date of a plurality of requests out of the plurality of users.

3. The sale management server according to claim 1,
wherein the arrival notification code is further configured to cause at least one of said at least one processor to notify the plurality of user terminals of the arrival while shifting a respective time of the notification of the plurality of user terminals based on the priority order.

4. The sale management server according to claim 3,
wherein the arrival notification code is further configured to cause at least one of said at least one processor to vary a shift amount of the time of the notification of the plurality of user terminals based on a value of the purchase eagerness value.

5. The sale management server according to claim 1, wherein said computer program code further comprises arrival schedule notification code configured to cause at least one of said at least one processor to:
calculate, when arrival schedule information including an arrival scheduled date of the product is received, the purchase eagerness value of the product for each of the users based on the number of requests of each of the users in the history stored in the history storage unit,
create the priority order for the plurality of users based on the calculated purchase eagerness value of each of the users, and
notify the user terminal of the plurality of users of an arrival of the product based on the priority order.

6. The sale management server according to claim 1, wherein said computer program code further comprises demand degree notification code configured to cause at least one of said at least one processor to:
generate demand degree information of the product based on the history stored in accordance with the history storage code, and
notify a terminal of a shop selling the product of the generated demand degree.

7. An information processing method of a sale management server, the information processing method comprising:
in response to a browsing request for a product page of a product from a user terminal, generating a first webpage configured to accept a purchase request in response to the product being an in-stock product and generating a second webpage configured to accept an arrival notification request in response to the product being an out-of-stock product;
transmitting the generated first webpage or the generated second webpage to the user terminal;
accepting a request for an arrival notification regarding the out-of-stock product from the user terminal;
storing, in a storage, a history of the request for the same product for each of a plurality of users, that has been accepted;
calculating a purchase eagerness value for the product for each of the users based on the number of requests for each of the users in the history stored in the storage;
creating a priority order for the plurality of users based on the calculated purchase eagerness value of each of the users; and
notifying the user terminal of the plurality of users of an arrival of the product based on the priority order.

8. A non-transitory computer-readable storage medium storing a program for causing a computer to execute a process, comprising:
in response to a browsing request for a product page of a product from a user terminal, generating a first webpage configured to accept a purchase request in response to the product being an in-stock product and generating a second webpage configured to accept an arrival notification request in response to the product being an out-of-stock product;
transmitting the generated first webpage or the generated second webpage to the user terminal;
accepting a request for an arrival notification regarding the out-of-stock product from the user terminal;
storing, in a storage, a history of the request for the same product for each of a plurality of users, that has been accepted by the accepting;
calculating a purchase eagerness value for the product for each of the users based on the number of requests for each of the users in the history stored in the storage;
creating a priority order for the plurality of users based on the calculated purchase eagerness value of each of the users; and
notifying the user terminal of the plurality of users of an arrival of the product based on the priority order.
